(19) United States
(12) Patent Application Publication
(10) Pub. No.: US 2026/0321462 A1
(43) Pub. Date: Oct. 15, 2026

(54) DYNAMIC POWER CABLE WITH COPPER-TIN ALLOY WATER BARRIER

(71) Applicant: PRYSMIAN S.p.A., MILANO (IT)

(72) Inventors: Luca COLCIAGO, MILANO (IT); Enrico Maria CONSONNI, MILANO (IT)

(73) Assignee: PRYSMIAN S.p.A., MILANO (IT)

(21) Appl. No.: 19/642,763

(22) Filed: Apr. 9, 2026

(30) Foreign Application Priority Data
Apr. 9, 2025 (IT) 102025000007755

(51) Int. Cl. H01B 9/02; H01B 1/02; H01B 7/02; H01B 7/18; H01B 7/288

(52) U.S. Cl. CPC H01B 9/021; H01B 1/026; H01B 7/0225; H01B 7/0291; H01B 7/1875; H01B 7/288; H01B 9/022; H01B 9/027

(57) ABSTRACT

A dynamic power cable containing:
at least one cable core (110) containing an electric conductor (115) surrounded by an insulating system (200);
a metal layer (120) in the form of a metallic foil (121) folded around the cable core (110) along a longitudinal direction (A), wherein the metal layer (120) is made of a copper-tin alloy having a tin content of from 0.5% to 14% by weight, with respect to the alloy total weight.

### RELATED APPLICATIONS

This application claims priority to Italian Patent Application No. 102025000007755 filed on Apr. 9, 2025, in the name of PRYSMIAN S.p.A., incorporated herein by reference as if fully written out.

### BACKGROUND OF THE DISCLOSURE

The present disclosure refers to a dynamic power cable, particularly but not exclusively useful for off-shore floating applications, e.g. wind farms.

For example said power cable can be a high voltage or an extra high voltage power cable.

In this specification, the expression “high voltage” (HV) indicates voltages equal to or greater than 30 kV, whereas the expression “extra high voltage” (EHV) indicates voltages equal to or greater than 300 kV.

A “dynamic cable” is a cable that is employed in floating off-shore applications, where the cable is subjected to variable dynamic loads induced by the sea waves, differently to a “static” cable that is not subjected, in use, to fatigue.

Typically, a power cable, particularly a HV or EHV power cable, includes at least one cable core usually formed by an electrically conductive metal conductor covered by an insulating system. The insulating system can be sequentially formed by an inner polymeric semiconductive layer, an intermediate polymeric insulating layer, and an outer polymeric semiconductive layer. The insulating system is usually then surrounded by a metal screen generally made of steel or copper and by a polymeric sheath which can be semiconductive or insulating. When the power cable comprises more than one cable core, e.g. three cable cores, the power cable may also comprise a filler material or shaped filling elements between the cores. The metal screen may be surrounded by a bedding layer which, in turn, may be surrounded by an armour. When a power cable is to be installed in a wet or potentially wet environment, such as underwater or underground, the cable core should be protected from moisture or water penetration that may lead to electrical breakdown. For this purpose, in submarine or high voltage (HV) or extra-high voltage (EHV) underground power cables, typically the metal screen is hermetically sealed and acts also as water barrier, surrounding the cable core/s of the power cable so as to block water penetration during installation and operation of the cable.

The hermetical seal can be obtained by longitudinally folding the water barrier material in the form of a foil around the cable core. The edges of the foil can be sealed head-to-head, through TIG (Tungsten Inert Gas) or laser welding, or overlapped and glued. The foil may have a thickness comprised between 0.1 mm and 2 mm and can be optionally corrugated in order to improve the material performances, typically when the foil thickness is greater than 0.4 mm.

For dynamic cables, the use of pure copper (Cu-OF, i.e. oxygen-free copper, or Cu-HCP, i.e. high purity copper) or stainless steel (in particular AISI 316L) for the screen/water barrier is known. These metals are suitable to this use because of their easy weldability, cold forming and fatigue and corrosion resistance, which are key features for dynamic cable applications. Pure copper is more commonly used because of its suitable electric resistivity and satisfactory welding performance. However, the mechanical properties of pure copper are not completely satisfactory, resulting in a low durability in dynamic applications. Additionally, the low electric resistivity of copper could give rise to current losses. On the other hand, stainless steel (AISI 316L) has good mechanical properties but poor electrical conductivity, unfavourable in case of short circuit. Different copper alloys can also be employed for the screen/water barrier of power cables. See, for example, EP 3 438 993 B1 disclosing the use of a copper-nickel alloy for submarine dynamic power cables, and EP 3 786 982 A1 disclosing a CuNiSi alloy for inner sheathing of submarine power cables.

EP 2 706 539 A1 relates to a cable for conducting electricity useful for subsea applications and having a water-blocking layer that is made of a copper alloy selected from alloys comprising copper and nickel; copper and beryllium; copper, zinc and aluminium; and copper and zinc.

### SUMMARY OF THE DISCLOSURE

The Applicant has faced the problem of providing a power cable, particularly to be employed in off-shore floating wind farms, having a screen/water barrier that has improved mechanical properties and specifically fatigue properties, which are crucial for dynamic applications, but also a resistivity higher than that of pure copper. To that purpose, the Applicant has considered to employ a copper-tin alloy.

Specifically, the Applicant has found out that in a copper alloy with a tin content of from 0.5% to 14% by weight the mechanical properties (in terms of tensile strength and yield strength) and fatigue properties are improved with respect to those of pure copper, while maintaining electrical properties suitable for an electric screen. Such alloys are also weldable by various technologies (TIG—Tungsten Inert Gas—, MIG—Metal Inert Gas—, laser) and have good cold deformability, making them an excellent compromise for the indicated application also when the screen/water barrier is corrugated, and suitable both for head-to-head welding and overlapping edges technologies.

According to a first aspect, the present disclosure relates to a dynamic power cable comprising:
at least one cable core comprising an electric conductor surrounded by an insulating system;
a metal layer in the form of a metallic foil folded around the at least one cable core along a longitudinal direction, wherein the metal layer is made of a copper-tin (Cu—Sn) alloy having a tin content of from 0.5% to 14% by weight, with respect to the alloy total weight. In an embodiment, the tin content is of from 0.5% to 10%. For example, the tin content is of from 1% to 7% by weight, with respect to the alloy total weight.

The Cu—Sn alloy of the present disclosure may contain small quantities of impurities. Such impurities may include lead, manganese, iron, zinc, and other metals.

These impurities may be present since they are typically either too difficult or costly to remove when a metal or an alloy is being produced. These impurities may be present in the range from 0.0001%, 0.001%, 0.005% or 0.01% to 0.1%, 0.5%, 1%, 2% or 4% (w/w). It will be appreciated such impurities in these amounts may be present in the alloy of the present disclosure without affecting or departing from the scope of the disclosure. The Cu—Sn alloy of the present disclosure may have an ultimate tensile strength of from 250 MPa to 550 MPa calculated according to ISO 6892-1:2009(E).

The Cu—Sn alloy of the present disclosure may have an elongation at break of from 15% to 50% calculated according to ISO 6892-1:2009(E).

The Cu—Sn alloy of the present disclosure may have an electric conductivity of from 10% IACS (International Annealed Copper Standard) to 25% IACS. IACS is a standard established in 1914 by the United States Department of Commerce. 100% IACS is equivalent to a conductivity of 58×10⁶ S/m at 20° C.

In an embodiment, the metal layer has a thickness of from 0.1 to 2 mm.

In an embodiment, the metal layer is corrugated.

In an embodiment, the metal layer has head-to-head welded edges.

In an alternative embodiment, the metal layer has overlapped longitudinal edges bonded together by means of a bonding material.

In an embodiment, the bonding material is metallic, for example based on copper.

In an embodiment, when the tin content is at least 8% by weight, with respect to the alloy total weight, the dynamic power cable comprises a pure copper layer, for example in form of tape or braids or wire, interposed between the cable core and the metal layer and in direct contact with the latter.

In the present description and claims as “pure copper” is meant a oxygen-free copper (Cu-OF) or a high purity (Cu-HCP). In any case the pure copper according to the present disclosure has an electrical conductivity of 98-100% IACS (International Annealed Copper Standard) at 20° C.

The metal layer of the cable of the present disclosure may act as both water barrier and electric screen.

The dynamic power cable according to the present disclosure may comprise from one to three cable cores. Each cable core is surrounded by a relevant metal layer according to the present disclosure.

In the present description and claims as “insulating system” is meant an assembly of, from the radially inner to the radially outer, inner semiconducting layer, insulating layer and outer semiconducting layer. The layer of the insulating system are based on polymeric material. Generally, the insulating system is manufactured by coextruding the just mentioned layers. In an embodiment, the cable core of the present cable further comprises at least one semiconductive water-swellable layer in direct contact with the outer semiconductive layer of the insulating system. In an embodiment, the semiconductive water-swellable layer is in direct contact with the present metal layer.

The semiconductive water-swellable layer may be in form of a tape helicoidally wound or longitudinally formed. In an embodiment, each cable core of the present description may further comprise a discontinuous electric shield surrounding the insulating system and in radially inner position with respect to the water barrier. The discontinuous electric shield is made of an electrically conductive material and may be in form of wires, braids, rods or helically wound tape/s.

When the discontinuous electric shield is present, each cable core of the present cable may comprise two semiconductive water-swellable layers in direct contact with such shield, one being in a radially inner position and the other in a radially outer position with respect to the discontinuous electric shield and in direct contact to the metal layer.

In an embodiment, the metal layer is surrounded and in direct contact with a semiconductive inner sheath which can be the outermost layer of the present cable.

The dynamic cable according to the present disclosure may further comprise at least one armour layer, for example two armour layers, surrounding the metal layer. The armour layer may be made of metal rods or wires, for example steel, or of high tensile polymeric bundles, for example aramid filament bundle. The at least one armour layer surrounds the metal layer/s and, accordingly, the relevant cable core/s. A bedding layer made of, e.g., polyethylene may be interposed between metal layer/s and armour.

When the dynamic cable according to the present disclosure comprises at least one armour layer, a jacket surrounding the at least one armour layer is present. The jacket may be made of extruded polyethylene, for example high density polyethylene (HDPE). When present, the jacket is the outermost layer of the present cable. For the purpose of the present description and of the claims that follow, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein. Also, the terms “a” and “an” are employed to describe elements and components of the disclosure. This is done merely for convenience and to give a general sense of the disclosure. This description should be read to include one or at least one, and the singular also includes the plural unless it is obvious that it is meant otherwise.

As “insulating layer” it is meant a layer made of a material having a conductivity comprised between 10⁻¹⁶ and 10⁻¹⁴ S/m.

As “semiconductive layer” it is meant a layer made of a material having a conductivity comprised between 10⁻¹ and 10 S/m.

As “dynamic” cable it is meant a cable used for the connection of floating off-shore platforms, for instance wind farms, and thus is employed undersea and is subjected to dynamic loads (fatigue) deriving from the floating platform.

The present disclosure, in at least one of the aforementioned aspects, can be implemented according to one or more of the present embodiments, optionally combined together.

### BRIEF DESCRIPTION OF THE DRAWINGS

Further characteristics will be apparent from the detailed description given hereinafter with reference to the accompanying drawings, in which:

FIG. 1 is a schematic perspective sectioned view of a dynamic power cable according to an embodiment of the present disclosure;

FIG. 2 is a schematic sectioned view of a dynamic power cable according to a different embodiment of the present disclosure;

FIG. 3 is the metal foil of the dynamic power cables of FIGS. 1-2 before being folded around the core;

### DETAILED DESCRIPTION OF SOME EMBODIMENTS

With reference to the Figures, a dynamic power cable 100 according to the present disclosure is schematically represented.

The dynamic power cable 100 according to the present disclosure can be HV or EHV, either AC or DC.

The dynamic power cable 100 comprises at least one cable core 110 extending along a longitudinal direction A.

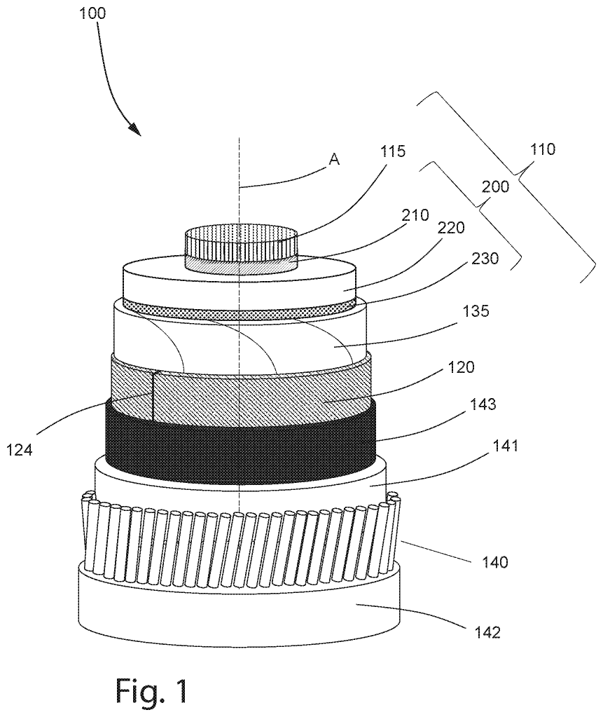

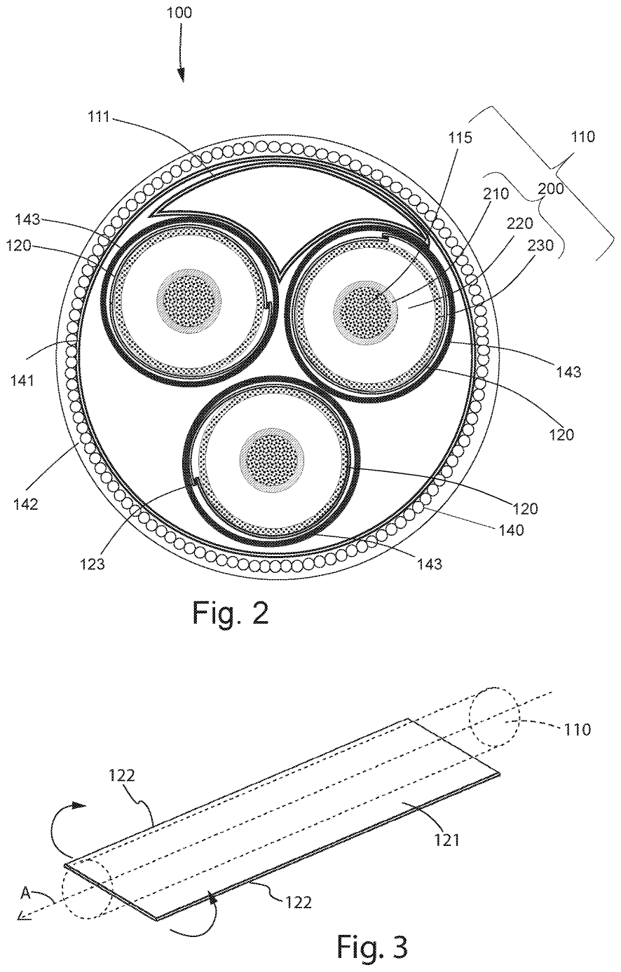

In the embodiment illustrated in FIG. 1, the dynamic power cable 100 comprises one cable core 110, while in the embodiment of FIG. 2 the cable 100 comprises three cable cores 110 helically assembled one another along a longitudinal axis A.

In all the embodiments, each cable core 110 comprises an electric conductor 115 surrounded by an electrically insulating system 200. Each electrically insulating system 200 is sequentially formed by an inner polymeric semiconductive layer 210, a polymeric insulating layer 220, and an outer polymeric semiconductive layer 230. The dynamic power cable 100 comprises a metal layer 120 in the form of a metallic foil 121 longitudinally folded around the cable core 110.

A discontinuous metal shield (not illustrated), made of an electrically conductive metal like copper, aluminium or composite thereof, in form of wires, braids or helically wound tapes may be present around each insulating system 200 and in radially internal position with respect to the metal layer 120.

A semiconductive water-swellable layer 135 (not shown in the cable of FIG. 2) can be provided around the or all of the insulating system/s 200 (and below the discontinuous metal shield, if present). Accordingly, the power cable 100 comprises such semiconductive water-swellable layer 135 which may be in direct contact with the metal layer 120. According to the present description, the water-swellable layer 135, if present, is part of the cable core 110. For example, the semiconductive water-swellable layer 135 may be in form of a tape helically wound or of a foil longitudinally wrapped. The semiconductive water-swellable layer 135 may be made of a non-woven fabric added with hydro-expansible powder like a polyacrylate and, for example, carbon black.

When the discontinuous metal shield is present, each cable core 110 may comprise two semiconductive water-swellable layers 135 in direct contact with such shield, one being in a radially inner position and the other in a radially outer position with respect to the discontinuous electric shield and in direct contact to the metal layer 120.

In the embodiment of FIG. 1, the metallic foil of the metal layer 120 has a welding 124 joining its longitudinal edges.

In the embodiment of FIG. 2, the longitudinal edges of the metal layers 120 are overlapped one another and bonded by a bonding material 123.

In an embodiment, the bonding material 123 may be, for example, a polymeric adhesive resin or an electrically conductive metal such as copper.

In case the bonding layer 123 is metallic, it can be made of copper as reported, for example, in EP4258294. In case the bonding layer 123 is a a polymeric adhesive resin, a metal coating, for example a copper coating, may be provided onto the overlapper edges and the bonding layer 123 as reported, for example, in EP3069354.

The dynamic cable 100 of FIG. 2 further comprises a filler placed in the spaces among the cable cores 110. The filler may be made, for example, of an extruded polymeric material, of polymeric filaments or may be plastic inserts 111 of substantially triangular cross-section (only one being shown, but three being actually present) as described, for example, in EP3244423A.

The metal layer 120 is made of a copper-tin alloy having a tin content of from 0.5% to 14% by weight, with respect to the alloy total weight.

In an embodiment, the tin content is of from 0.5% to 10% by weight, with respect to the alloy total weight.

In an embodiment, the tin content is of from 1% to 7% by weight, with respect to the alloy total weight.

The metal layer made of such an alloy can withstand cold forming and welding (i.e. gas shielded arc welding and laser welding).

The metal layer 120 can have a thickness of from 0.1 to 2 mm. In an embodiment, the metal layer 120 has a thickness of from 0.1 to 1.5 mm.

In an embodiment, the metal layer 120 is corrugated. In an embodiment, the metal layer 120 is corrugated and has a thickness greater than 0.4 up to 1.5 mm.

As already said above, the metal layer of the present dynamic cable may have head-to-head welded edges or edges overlapped longitudinally and bonded together by means of a bonding material 123.

In an embodiment, the present metal layer has head-to-head welded edges and a thickness from 0.4 to 1.5 mm.

In an embodiment, the present metal layer has edges overlapped and bonded together by a bonding material, and a thickness from 0.1 to 0.4 mm.

In an embodiment, when the metal layer 120 has a tin content of at least 8% by weight, with respect to the alloy total weight, the dynamic power cable 100 of the present disclosure may comprise a pure copper layer (not illustrated) interposed between the cable core 110 and the metal layer 120 in direct contact thereto.

The pure copper layer is positioned in radially internal position with respect to the metal layer 120 and in radially external position with respect to the semiconductive water-swellable layer 135, if present. In an embodiment, the pure copper copper layer may be positioned between two water-swellable layers 135. The pure copper layer may be in in form of tape or braids or wire. The thickness of the pure copper layer depends upon the overall cable and metal layer design and may be suitable selected by the skilled person.

In an embodiment, the dynamic power cable 100 of the present disclosure further comprises at least one armour layer 140. In the cables 100 of FIGS. 1 and 2, the armour layer 140 is a one-layer armour made of wires which can be metallic, polymeric or both. The armour layer 140 is provided around the metal layer 120 and separated thereto by, sequentially, an inner sheath 143 and a bedding layer 141. Both the inner sheath 143 and the bedding layer 141 may be made of a polymeric material, optionally added with semiconductive material, like carbon black, in the case of the inner sheath.

A jacket 142 made, for example, of polyethylene like HDPE surrounds the armour layer 140, as radially outermost layer.

In other embodiments not illustrated, the power cable may be armourless. In this case, the cable outermost layer is the inner sheath 143, i.e. the polymeric layer directly contacting the metal layer 120 of the present disclosure.

An adhesive layer (not illustrated) can be interposed between the metal layer 120 and the inner sheath 143 in order to ensure adhesion of the inner sheath 143 with the metal layer 120.

As from FIG. 3, the metal layer 120 of the present disclosure may be manufactured by longitudinally wrapping a metal foil 121 around the cable core 110. In an embodiment, the longitudinal edges 122 may be sealed head-to-head by TIG or laser welding. In an embodiment, a metal protective strip may be provided over the power cable core 110 in a position substantially matching a welding, as disclosed in EP3792938B. In another embodiment, the longitudinal edges 122 may be overlapped and glued one another by a bonding material 123. When the bonding material is dielectric (i.e. non metallic), a metal coating may be provided as disclosed, for example, in EP3069354.

According to the present disclosure, the metal layer acts both as electric screen and water-barrier in cable. Thanks to the alloy of the present disclosure, the metal layer can withstand higher fatigue and corrosion resistance than pure copper, thus being a better water barrier. At the same time, the present alloy has an electric conductivity suitable for an electric screen, which could not be for a stainless steel layer as stainless steel AISI 316L, generally used for water barrier application, which has an electric conductivity of 2.3% IACS.

### Examples

Test carried out by the Applicant showed that a metal layer made of the present alloy had a suitable electrical conductivity, which is lower than that of pure copper (high purity copper Cu-HCP or oxygen-free copper Cu-OF) but greater than that of stainless steel (stainless steel AISI 316L conductivity: 2.3% IACS), and substantially better mechanical properties than pure copper, especially in terms of ultimate tensile strength (Rm) and yield strength (Rsn).

The mechanical properties measured, reported in the tables below, are the ultimate tensile strength (Rm), measured according to ISO 6892-1:2009(E); the yield strength (Rsn) and the elongation to fracture (A_{50 mm}) measured according to ISO 6892-1:2009(E) standard. In addition, in the tables below the electrical conductivity is reported as measured in annealed temper at 20°.

In the table:
Cu-HCP-A and Cu-HCP-B are high-purity copper; UNS (Unified Numbering System) C10300;
Cu-OF-A and Cu-OF-B are oxygen-free copper; UNS C10200;
CuSn0.20 is a Cu—Sn alloy containing 0.2 wt % of tin; UNS C14410;
CuSn4-A and CuSn4-B are two different temper grades of a Cu—Sn alloy containing 4 wt % of tin; UNS C51100;
CuSn5-A and CuSn5-B are two different temper grades of a Cu—Sn alloy containing 5 wt % of tin; UNS C51000;
CuSn6-A and CuSn6-B are two different temper grades of a Cu—Sn alloy containing 6 wt % of tin; UNS C51900;
CuSn8-A and CuSn8-B are two different temper grade of a Cu—Sn alloy containing 8 wt % of tin; UNS C52100.

The metals marked by an asterisk (*) are comparative metals.

| | | | | | Electric |
|---|---|---|---|---|---|
| | Temper | Rm | A_{50 mm} | Rsn | Conductivity |
| Metal | Grade | [N/mm²] | [%] | [N/mm²] | [% IACS] |
| Cu-HCP-A* | R220 | 220-260 | 33 | ≤140 | 98 |
| Cu-HCP-B* | R360 | ≥360 | 2 | 320 | 98 |
| Cu-OF-A* | R220 | 220-260 | 33 | ≤140 | 100 |
| Cu-OF-B* | R290 | 290-360 | 4/6 | 250 | 100 |
| CuSn0.20* | R300 | 300-370 | 10 | 270 | 76 |
| CuSn4-A | R290 | 290-390 | 40 | ≤190 | 21 |
| CuSn4-B | R390 | 390-490 | 20 | ≥320 | 21 |
| CuSn5-A | R310 | 310-390 | >45 | ≤250 | 17 |
| CuSn5-B | R490 | 490-580 | 19 | ≥450 | 17 |
| CuSn6-A | R350 | 350-420 | 45 | ≥300 | 16 |
| CuSn6-B | R420 | 420-520 | 29 | ≥350 | 16 |
| CuSn8-A | R370 | 370-450 | 35 | ≥300 | 11 |
| CuSn8-B | R450 | 450-550 | 35 | ≥370 | 11 |

The alloys according to the present disclosure have an electric conductivity IACS lower than that of Cu-HCP-A/B, Cu-OF-A/B and the comparative alloy CuSn0.20, but sufficient for metal layers useful as electric screen of a power cable, for example of a high voltage power cable. The lower electric conductivity of the present alloys is positive in that they give rise to lower or null current losses. In the case of CuSn8-A and CuSn8-B having an electric conductivity of 11% IACS, a metal layer made of one of these alloys could be joined with a pure copper sheet in radially internal position.

The alloys according to the present disclosure have overall mechanical properties better than that of the comparative metals, making them a better material for a water barrier in a dynamic cable. As for pure copper (Cu-HCP-A/B and Cu-OF-A/B), when the ultimate tensile strength (Rm) is comparable to that of the alloys of the present disclosure, the elongation at fracture (A_{50 mm}) is greatly lower and this entails a greater fragility of the cable when bent or generally handled. On the reverse, when the elongation at fracture (A_{50 mm}) is comparable to that of the alloys of the present disclosure, the ultimate tensile strength (Rm) is greatly lower and this entails the cable incapability to sustain tension. The same applies to the comparative alloy CuSn0.20 (having a tin content out of the range of the disclosure).

In all of the alloys of the examples the Applicant detected very good cold forming properties (comparable to pure copper), good ability to be subjected to gas shielded arc welding and laser welding, and good corrosion resistance.

1) A dynamic power cable comprising:
at least one cable core comprising an electric conductor surrounded by an electrically insulating system;
a metal layer in the form of a metallic foil folded around the cable core along a longitudinal direction (A), wherein the metal layer is made of a copper-tin alloy having a tin content of from 0.5% to 14% by weight, with respect to the alloy total weight.

2) The dynamic power cable according to claim 1, wherein the tin content is of from 0.5% to 10% by weight, with respect to the alloy total weight.

3) The dynamic power cable according to claim 1, wherein the tin content is of from 1% to 7% by weight, with respect to the alloy total weight.

4) The dynamic power cable according to claim 1, wherein the metal layer has a thickness of from 0.1 mm to 2 mm.

5) The dynamic power cable according to claim 1, wherein the metal layer is corrugated.

6) The dynamic power cable according to claim 1, wherein the metal layer has head-to-head welded edges.

7) The dynamic power cable according to claim 1, wherein the metal layer has overlapped longitudinal edges bonded together by means of a bonding material.

8) The dynamic power cable according to claim 7, wherein the bonding material is metallic.

9) The dynamic power cable according to claim 1, wherein the tin content is at least 8% by weight, with respect to the alloy total weight, and the dynamic power cable comprises a pure copper layer interposed between the cable core and the metal layer and in direct contact with the metal layer.

10) The dynamic power cable according to claim 1 comprising from one to three cable cores and each cable core is surrounded by a relevant metal layer.

11) The dynamic power cable according to claim 1 comprising a semiconductive water-swellable layer in direct contact with the metal layer.

12) The dynamic power cable according to claim 1 comprising at least one armour layer surrounding the metal layer.
